(19) United States
(12) Patent Application Publication
(10) Pub. No.: US 2005/0143102 A1
(43) Pub. Date: Jun. 30, 2005

(54) Method and system for user-definable fun messaging

(76) Inventors: Carlos I. McEvilly, Cupertino, CA (US); Manjirnath A. Chatterjee, Sunnyvale, CA (US); Jin Guo, Sunnyvale, CA (US); Jens Nagel, San Francisco, CA (US); Rudolf Schusteritsch, Mountain View, CA (US); Marie E. White, Stanford, CA (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/747,634

(22) Filed: Dec. 29, 2003

(51) Int. Cl. H04Q 7/20

(52) U.S. Cl. 455/466

(57) ABSTRACT

A method and apparatus are used for encoding (310) and decoding (408) a message encoded with at least one entertainment component after receiving the message contents from a sender. Instructions from the sender are used for selecting (304) the encoding method for the message content to provide the entertainment component. When the selected encoding method is not available locally, it may be downloaded (306) to the electronic device (200). The encoded message may be supplemented (316) with descriptive information regarding the encoding method used to provide the entertainment component of the encoded message. The encoded message may include aural, haptic and visual elements as part of the entertainment component. The entertainment component may include optional game elements requiring a recipient or viewer to play (410) the game to view (412) the message contents.

### TECHNICAL FIELD

This invention relates in general to communication systems, and more specifically to a method and apparatus for providing user-definable fun messaging.

### BACKGROUND OF THE INVENTION

Electronic mail, short message service (“SMS”), enhanced message service (“EMS”), multimedia message service (“MMS”) all exist. They serve to communicate information between people, often using a cellular phone or other wireless communication device. EMS and MMS offer an opportunity to send and receive messages beyond the text-only format of SMS using graphics, sounds and even full motion graphics. However, EMS and MMS are often not popular with users due to the difficulty in creating such messages, especially on a small screen or with a limited user interface that is often the case with a wireless communication device. System operators are interested in promoting the advanced features of EMS and MMS for the revenue potential of larger messages and perhaps more frequent message traffic.

Emoticons are facial expressions made by a certain series of keystrokes. Most often emoticons are an image of a face sideways, such as :) to represent a smile and ;) to represent a wink. A list of emoticons can be found at many public Internet sites. Early emoticons were known on the “Plato” computer system as early as the mid-1970's. Other current attempts to substitute a graphic for a predetermined string of typed characters are known in some instant messaging (“IM”) systems. For example, Yahoo! Messenger documents a series of graphics that will be substituted during transmission of a message.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a simplified and representative block diagram of a communication system;

FIG. 2 is a simplified and representative block diagram of an electronic device capable of wireless communication;

FIG. 3 is a flow chart for creation of a message incorporating user-definable fun messaging; and

FIG. 4 is a flow chart for decoding and interacting with message incorporating user-definable fun messaging.

### DETAILED DESCRIPTION

In overview, the present disclosure concerns electronic devices that are capable of sending and receiving messages and more particularly to a method and apparatus for encoding and decoding messages with user-definable fun messaging.

Various inventive concepts and principles embodied in methods and apparatus for the creation, review, and ultimately the receipt and viewing of messages with user-definable fun messaging content are described and developed. The electronic devices of particular interest are those with a certain level of processing and multimedia capability, that is, in most cases, processing power sufficient to perform algorithmic operations on a file, to animate a graphic and to support a color display and sounds, preferably polyphonic sounds and music.

As further discussed below various inventive principles and combinations thereof are advantageously employed to manage the creation of simple messages and then operate on the message to add or substitute additional data, multimedia elements, and game, puzzle or other interactive elements. Such elements may simply overlay the original message data or may entirely transform the message into a new message or a new format.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

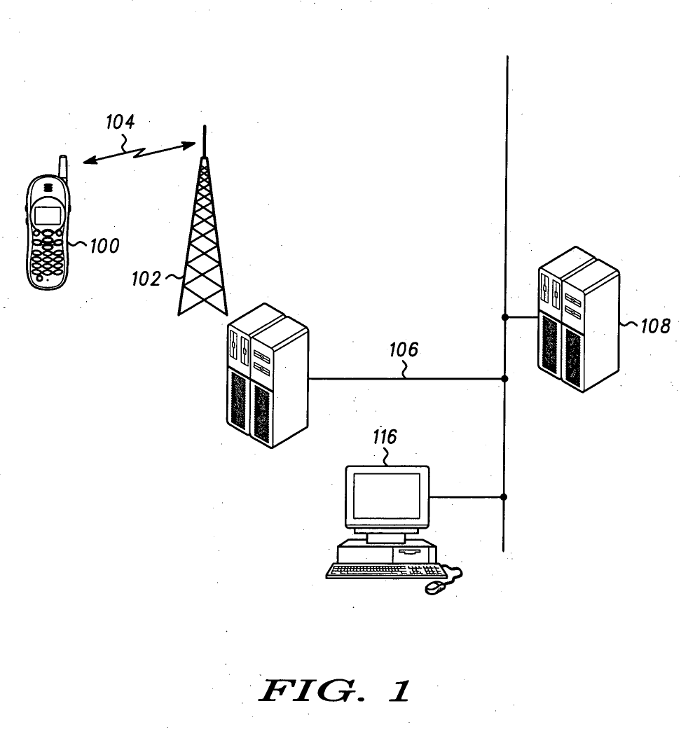

Referring to FIG. 1, a simplified and representative block diagram of a communication system is discussed and described. An electronic device 100 communicates with a communication infrastructure 102 over a communication channel 104. The communication infrastructure 102 is coupled to a network 106, preferably the Internet, but the network 106 may also be a corporate, enterprise or other network. The network 106 may be coupled to a server 108 or a personal computer (“PC”) 110. Messages created on the electronic device 100 can be communicated over the communication channel 104 to the PC 110 via the network 106 and any intervening servers, routers or similar structures associated with the network 106. Similarly, messages created on the PC 110 can be communicated over the same path, such as through the Internet over the communication infrastructure 102 to the electronic device 100. The server may be a source of information, such as software methods, or a component of the network 106 for routing and storage, or a host environment for a web server or other network resource.

In one embodiment, the electronic device 100 is a wireless communication device, although in another embodiment, the PC 110 could also serve as a host with respect to creating and viewing the enhanced messages described herein. As discussed further below, the electronic device 100 is used to capture the contents of a message to be sent to another user. Typically, this would be text entered by keystrokes, but could also be a previously received message or contents copied from a web site or bulletin board. After the contents of the message has been captured, it may be shown on the display of the electronic device, and options for transforming or altering or otherwise enhancing the message are displayed. At that point, the user can select from a list of options to complete the encoding process. New selection options and the associated software for carrying out the encoding can also be downloaded from a server 108. After the message has been transformed, the user has the option of reviewing the message, one option being reading or interacting with the message in the same manner that a recipient of the encoded message will see it. In one embodiment, the operator of the communication infrastructure 102, for example a wireless communication service provider, may charge extra for handling these encoded messages. In another embodiment the creation and distribution of enhanced messages could be part of a subscription package. The server 108, in addition to being a source of message transformation, options could also be used to store and distribute messages to, for example, a PC 110 or to other electronic devices such as another wireless communication device.

The elements of the system in FIG. 1 are known and available. The electronic device 100, in this instance, a wireless communication device, is available from manufactures such as Motorola. The communication infrastructure 102 similarly is available from companies such as Motorola, in one instance under the brand name of Nextel and the iDEN™ trademark (iDEN is a trademark of Motorola, Inc.). The server 108 could be any standard off-the-shelf computer system designated for that purpose, from companies such as Sun, Hewlett Packard, or Dell and run using Windows or UNIX operating systems. The PC 110 similarly could be from a number of manufacturers and typically run Microsoft Windows operating systems.

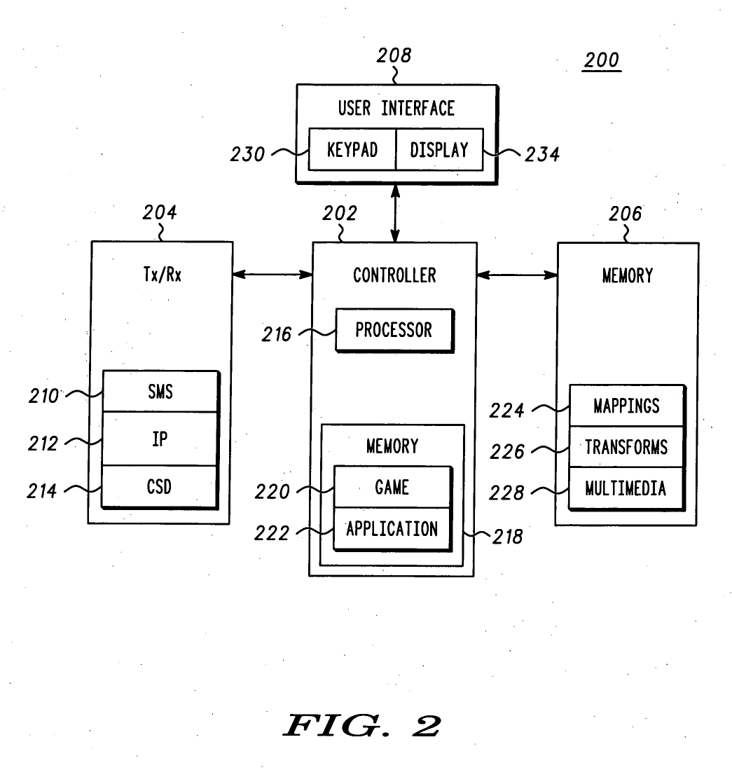

Referring to FIG. 2, a simplified and representative block diagram of an electronic device 200 capable of wireless communication is discussed and described. A controller 202 is coupled to a transceiver 204. The controller 202 is also coupled to a memory 206 and a user interface 208. The transceiver 204 is capable of communication methods which may include some or all of short message service 210, internet protocol 212, or circuit switch data 214. The controller 202 is further comprised of a processor 216. The internal memory 218 may be used to store process-specific machine code for the operating system (not shown), games 220 or game template for message transformation, as well as other applications 222. The memory 206 is shown as external memory but may, in some embodiments, actually be a part of the controller 202 in addition to its existing internal memory 218. The memory 206 as shown can also be used for storing machine code instructions for the specific operation of the controller. In addition, the memory can be used to store mappings 224, transforms 226 and multimedia services 228, all of which can be used in various forms to enhance or transform the message contents to be sent. The user interface 208 is comprised generally of a keypad 230 and a display 234. In a preferred embodiment, the display may be a color display.

The elements of the electronic device 200 are know and available. The controller 202 may be or may contain a digital signal processor. Such devices are known and available from semiconductor manufacturers such as Motorola. The transceiver circuitry 204 may be a single chip or may be a chip-based design with external analog components generally available from a variety of semiconductor manufacturers. Different protocols may be supported in the same or in different embodiments of the chip set. These protocols may include the Global System for Mobile Communications (GSM), the Enhanced Data-rate for GSM Evolution (EDGE), the General Packet Radio Service (GPRS), the Universal Mobile Telecommunications System (UMTS), Frequency Division Multiple Access (FDMA), the IS-55 Time Division Multiple Access (TDMA) digital cellular, the IS-136 TDMA digital cellular, the IS-95 Code Division Multiple Access (CDMA) digital cellular, demand assignment schemes (DA/TDMA, DA/CDMA, DA/FDMA), the Wideband Code Division Multiple Access (WCDMA), CDMA 2000, IMT-2000, the Personal Communications System (PCS), 3GPP, as well as variations and evolutions of these protocols. The memory 206 may be or may include both volatile and non-volatile memory and are available from a variety of semiconductor manufacturers. The user interfaces are comprised of a variety of standard components. The keypad 230 and the display 234 are both commodity items and are available from a variety of manufacturers and are found commonly in electronic devices including cellular telephones.

In operation, the electronic device 200 provides an encoded message. A user interface 208 may be used to enter message content, such as a text message. Whether the message content is entered at the user interface by typing or speech recognition for example, or obtained from other sources suggested above, it is envisioned that icons, pull down menus or the like may be used to present the user with options for encoding the message content. The selection of encoding options may be made at any point in the message creation process, that is, a selection could be made prior to, during or after the entry of the message content. The processor 216 then can receive the message content from the user interface 208 as well as one or more instructions for encoding the message content. The processor then provides the encoded message according to the instructions. The encoded message comprises at least one entertainment element.

Some definitions may be useful with reference to the following section.
Mapping—A rule of correspondence established between sets that associates each element of a set with an element in the same or another set. (The American Heritage® Dictionary of the English Language, Fourth Edition Copyright© 2000 by Houghton Mifflin Company)
Transformation—Replacement of the variables in an algebraic expression by their values in terms of another set of variables. (Id.)
Puzzle—Something, such as a game, toy, or problem, that requires ingenuity and often persistence in solving or assembling. (Id.)

The choices offered for providing the entertainment component may include mapping the message content wherein portions of the message content, such as individual words are substituted with other words, a symbol, audio portions, or animations. Similarly, the user may be provided with the choice of transforming the message wherein specific elements of the message content, such as a word or a phrase, are recoded into an entirely different form or format. For example, the words “meet for lunch” may be removed, and a graphic or multimedia segment depicting a person walking into a restaurant may be substituted. Another selectable element may be to take the actual message content such as the text and form it into a puzzle, the puzzle being perhaps a crossword puzzle, a scrambled letter puzzle, or hidden word search, wherein the recipient of the message must actually solve the puzzle to read the message.

The mappings and transformations may include replacement of an element, that is, when a word is actually substituted with sounds that may actually be the word or represent the word. Similarly, the substitution may involve a visual element where a word such as “fire” is substituted with a graphic or multimedia depiction of a fire. Haptic elements can also be incorporated, for example, the phrase indicating that someone should make a phone call, “give me a buzz”, could be accompanied or substituted with actually activating the silent ringer of a cell phone to “buzz” the device. To clarify this action from an actual ring associated with an incoming call a corresponding visual indication may be provided such as a moving cursor or scrolling indicator that steps through the text and substitutions.

In performing the mappings 224, transformations 226, or substitution of multimedia elements 228 the processor 216 may rely on an application 222 or utility program or series of programs contained in the local memory 206, 218 which would perform specific actions based on the selection from the user. In some cases, the user may be provided with a list of selections wherein some of the selections require routines not currently present in the local memory 206, 218 of the electronic device 200. In such a case, the processor 216 may access the network 106 through the transceiver 204 to download from a server 108 the appropriate encoding or mapping method that was selected by the user. In one embodiment, the mapping or transformation methods would include a series of words or phrases that can be stored in a look-up table for the purpose of substituting text of the message content with other elements. It is anticipated that a certain number of words and phrases would be built into the program but one embodiment would allow the user to supplement the table with his or her own words, phrases, and the mappings or transformations that would be associated with such words and phrases.

The primary target of the encoded message would be the recipient of the encoded message. However, it is likely that the sender, while in the process of creating the mappings and transformations, would also receive an entertainment value from the actual process, either by observing the transformations and mappings that take place in real time or by playing the message either prior to sending or after sending. Thus the sender is offered the opportunity to have the same experience as the viewer of the message and later interact with the viewer to discuss or describe what was sent.

In one embodiment of the mapping or transformation process, the processor 216 could place tags in the message content where substituted text was removed or place tags in addition to the text targeted by the transformation or mapping process. When the message is thus sent to the recipient, the multimedia elements or substituted elements may accompany the message or they may be expected to reside on the target device and inserted at the appropriate tag. The substituted elements not already in the target device could be added in a server 108 during the message transfer process or the elements could be downloaded at the time the message is played by the recipient of the message.

In another embodiment, the message content is not transformed or mapped but rather is hidden until the results of a game played by the recipient are known. That is, the words of the message could be hidden from view, and a game, such as hangman, could be played. When the game is successfully completed, it may reveal all or a portion of the message content to the viewer as a reward. In another embodiment, a “run and jump” game actor has to achieve a certain level of success in accomplishing a task or completing a course before the message content is revealed. A series of tasks may be used to release various words, phrases, or sentences of the message content. It is thus possible that if the recipient does not successfully accomplish the task, the message may not be revealed. While this may not be an ideal case for business communications, certainly it may be used for entertainment and general messaging as this may provide a unique opportunity for parties to interact with each other. The message may be tied to virtually any game type, including multiplayer games. In one embodiment the enhanced message may be sent to multiple recipients who then engage in a multiplayer game. The winner is rewarded with the message content and the losers may have to accomplish a different task to see the message.

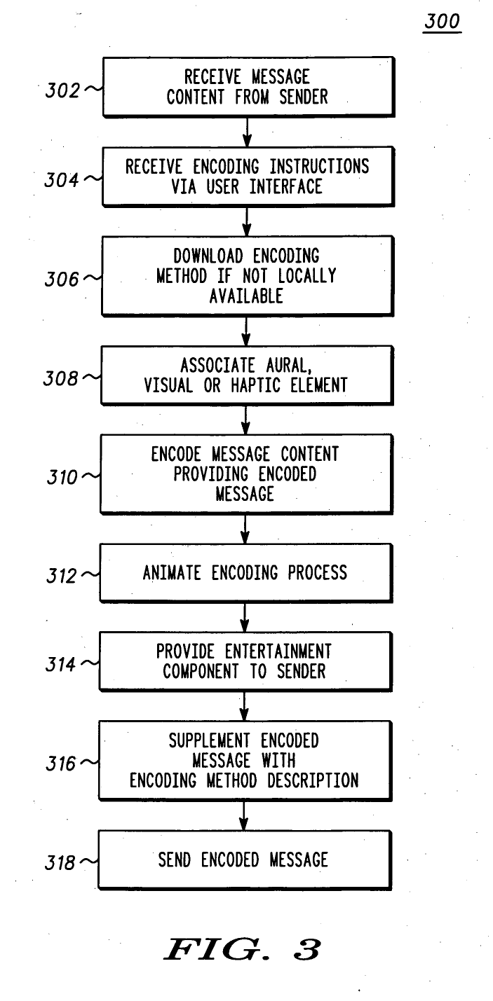

Referring to FIG. 3, a flow chart for creation 300 of a message incorporating user-definable fun messaging is discussed and described. A message, more specifically message content, is received 302 from a sender of the message. The message content may be text, but may include elements of other media types. Instructions for selecting an encoding method are received 304 from the sender of the message. The encoding method operates to provide a message having entertainment elements in conjunction with the message content. That is, the purpose of the encoding is to transform or otherwise modify the message content so that the sender, but particularly the recipient or viewer, of the message content so encoded is able to enjoy an amusing or diverting interaction with the message beyond the simple reading or viewing of the message content.

The requested encoding method may require a software method, subroutine or other program designed for such a purpose and may be a standalone function or may be incorporated into another element of the electronic device such as a messaging application. New encoding methods may be downloaded 306 to the electronic device 200 when a listed encoding application is not available locally in the electronic device 200, or as new encoding methods become available. Updates to encoding methods can be discovered on and downloaded from a network 106 accessible server 108. The encoding 310 itself may incorporate the addition of aural elements such as sounds or speech, either prerecorded or synthesized. The encoding may also incorporate visual elements such as animations, graphics or video clips. As discussed above, a third example of encoding could include haptic elements using existing or specialized hardware.

In practice, the encoding may require or comprise mapping elements of the message content to another element. The mapping may take the form of substituting a word from the message content with another word, for example from a look-up table, substituting the word with a symbol, substituting the word with audio or video segments, or substituting the word with an animation. Another method of creating the encoded message may be to transform the message content. The transformation may involve modifying the message content with an algorithm, modifying the message content to a multimedia format, or modifying the message content to an interactive format, such as a game. When transformed into a game, the message content may be revealed upon achieving a certain score, when the game incorporates score-keeping. Alternately, the message content may be revealed when certain milestones are reached in playing the game. The actual process for accomplishing the encoding is easily within the grasp of one of ordinary skill in the software arts. For example, as mentioned above, a look up table can be incorporated for substituting a given word for another element. As another example, an algorithm for using message text to create a background or other element of a game can be developed without undue experimentation.

Part of the entertainment value for the user may include offering an animation 312 of the actual encoding 310 process, where the user, that is, the creator of the message content may view the steps or process of adding or substitution of the entertainment elements with the message content. Thus, by either interacting with the encoding process 310 or the animation 312 of the encoding process or by interacting with the finished encoded message the sender is provided with entertainment 314. It is envisioned that numerous encodings could be comprised in a single message but at a minimum the encoded message would comprise at least one entertainment component. It may be important for the electronic device of the recipient or viewer of the encoded message to have information about the encoding method itself, including but not limited to the encoding routine itself, scoring limits, timeouts, or passwords for bypassing the encoding. This meta-data may be used to supplement 316 the encoded message. When the encoding is complete and any meta-data is appended, the message may be sent 318.

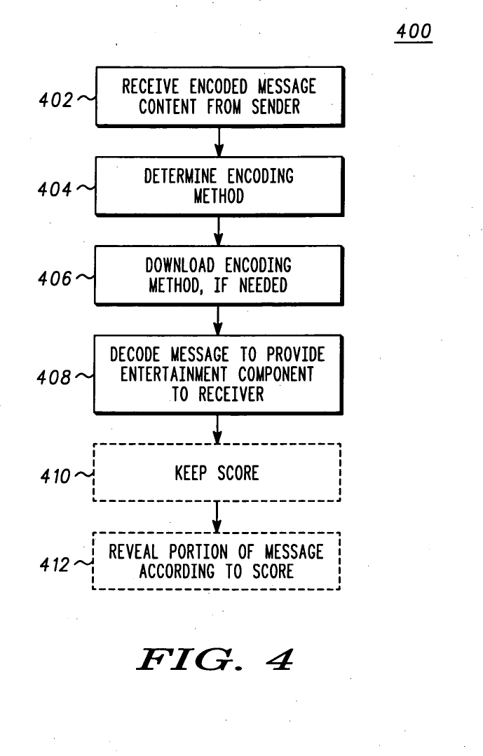

Referring to FIG. 4, a flow chart for decoding and interacting with message incorporating user-definable fun messaging is discussed and described. When message content has been encoded with at least one entertainment component using the process 300 to provide an encoded message, it is a logical next step to have a recipient or viewer receive 402 the encoded message. An electronic device of the recipient or viewer may determine 404 the encoding method using the supplemental data sent with the encoded message and use that to select the appropriate decoding method. When the needed method or software routine for decoding the message is not available locally on the electronic device it may be obtained by downloading over a network 106 or a wireless infrastructure 102. Part of the supplemental data accompanying the encoded message may include a URL or other address data specifying where the component may retrieved. It may be that method or routine is available for no charge, or a fee may be required. Alternately, the fee may be paid by the sender so as to not inconvenience the recipient or viewer. Access to encoding methods and new releases of encoding methods may be offered by subscription to either or both of the sender or recipient.

When the necessary decoding methods or software routines are available the message can be decoded 408 and provide entertainment to the recipient or viewer of the encoded message using the entertainment component provided. While the entertainment may be provided by static viewing one embodiment incorporates interacting with the encoded message. As discussed above, an optional method of interacting with the encoded message comprises keeping 410 a score, as in playing a game, wherein a predetermined score or a level of accomplishment is required to view 412 a portion of the encoded message.

The processes and apparatus discussed above, and the inventive principles thereof are intended to and will generate excitement and interest in sending and receiving messages, particularly multimedia messages. The use of these principles in mapping and transformation of messages offers simple and previously unavailable ways to author unique and entertaining messages for those without significant time or programming skills. Additionally, the methods and practices revealed are particularly suited to the small screens and limited user interfaces of small electronic devices such as cellular phones, personal digital assistants and other wireless communication devices.

Neither the creator nor the recipient of the message is required to have computer or multimedia training to enjoy the benefits of encoded messages with entertainment components. The ability to add in transit the substantive entertainment components, such as video clips, saves local memory and may lower over-the-air transmission costs. The ability to discover and download new encoding methods keeps the entertainment value fresh and provides developers and operators with potential revenue streams to reward such efforts.

Using the inventive principles and concepts disclosed herein advantageously allows or provides for simple, easy access to advanced multimedia message services to provide entertainment and enjoyment which will be beneficial to senders and recipients alike while giving a welcome additional capability to service providers.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A method of preparing a message comprising:
receiving a message content and an encoding method associated with the message content; and
encoding the message content to provide an encoded message, the encoded message comprising at least one entertainment component.

2. The method of claim 1 further comprising providing an animation of the encoding method.

3. The method of claim 1 further comprising allowing the sender to interact with the encoded message.

4. The method of claim 1 wherein encoding the message content further comprises one of mapping the message content and transforming the message content.

5. The method of claim 4 wherein mapping places a tag in a message and the substitution is performed while the message is one of in transit to a recipient and after receipt by the recipient.

6. The method of claim 1 wherein encoding the message content further comprises one of substituting a word with another word, substituting the word with a symbol, substituting the word with audio, and substituting the word with an animation.

7. The method of claim 1 wherein encoding the message content further comprises one of modifying the message content with an algorithm, modifying the message content to a multimedia format, and modifying the message content to an interactive format.

8. The method of claim 7 wherein modifying the message content to an interactive format further includes modifying the message content to include a score-keeping component.

9. The method of claim 1 further comprising associating an aural, visual or haptic element with the encoded message.

10. The method of claim 1 further comprising downloading a software component for performing the encoding method.

11. The method of claim 1 wherein receiving the message content includes receiving at least one of text, graphics, audio, video, digitized photographs and multimedia.

12. The method of claim 1 wherein the encoding the message content further comprises encoding the message content to provide the at least one message component, the at least one message component comprising one of an added data, a data substituted for an existing data, a multimedia element, a game, a puzzle and an interactive element.

13. The method of claim 1 further comprising supplementing the encoded message with a description corresponding to an encoding method used to provide the encoded message.

14. A method of processing an encoded message comprising:
receiving the encoded message, the encoded message comprising a message content and at least one entertainment component;
determining a decoding method according to supplemental data accompanying the encoded message; and
providing the message content and the at least one entertainment component to a recipient of the encoded message.

15. The method of claim 14 wherein receiving the encoded message further comprises receiving the at least one entertainment component having one of an aural, visual or haptic element.

16. The method of claim 14 further comprising selecting a software component for interacting with the encoded message using information provided with the encoded message.

17. The message of claim 16 further comprising obtaining the software component when it is unavailable locally.

18. The method of claim 14 further comprising interacting with the encoded message.

19. The method of claim 18 wherein interacting with the encoded message further comprises keeping a score while interacting with the encoded message, wherein a predetermined score is required to view a portion of the encoded message.

20. The method of claim 14 wherein the providing the message content and the at least one entertainment component further comprises providing the at least one entertainment component having one of an added data, a data substituted for an existing data, a multimedia element, a game, a puzzle and an interactive element.

21. A electronic device for providing an encoded message comprising:
a user interface for entering a message content; and
a processor coupled to the user interface, the processor for receiving from the user interface the message content and an instruction for encoding the message content, wherein the processor provides the encoded message according to the instruction, the encoded message comprising at least one entertainment element.

22. The electronic device of claim 21 wherein the at least one entertainment element comprises one of an aural element, a visual element and a haptic element.

23. The electronic device of claim 22 wherein the processor substitutes a portion of the message content with the one of the aural element, the visual element and the haptic element to create the encoded message.

24. The electronic device of claim 21 wherein the processor alters the message by means of an algorithm to provide a portion of the message as a puzzle, the puzzle being the at least one entertainment element of the encoded message.

25. The electronic device of claim 21 wherein the at least one entertainment element is a game and a text portion of the message is associated with the game.

26. The electronic device of claim 21 wherein the at least one entertainment element is a multimedia element and the multimedia element comprises one of text from the message content and symbols representing one of text, graphics, audio, video, digitized photographs and multimedia from the message content.

27. The electronic device of claim 21 wherein the at least one entertainment component comprises one of an added data, a data substituted for an existing data, a multimedia element, a game, a puzzle and an interactive element.
